(19) United States
(12) Patent Application Publication
(10) Pub. No.: US 2015/0058143 A1
(43) Pub. Date: Feb. 26, 2015

(54) LOAN MANAGEMENT SYSTEM AND METHOD OF ENROLLING A CUSTOMER IN AN INSTALLMENT PLAN

(71) Applicant: BRIGHTSTAR CORPORATION, Miami, FL (US)

(72) Inventors: Andy Zeinfeld, Miami, FL (US); Jeffrey Krisel, Miami, FL (US)

(21) Appl. No.: 14/469,301

(22) Filed: Aug. 26, 2014

Related U.S. Application Data
(60) Provisional application No. 61/869,903, filed on Aug. 26, 2013.

(51) Int. Cl. G06Q 40/02; G06Q 20/20

(52) U.S. Cl. CPC G06Q 40/025; G06Q 20/20
USPC 705/16; 705/38

(57) ABSTRACT

A method for enrolling a customer in an installment plan comprises the steps of receiving by a first processor at a point of sale terminal within a merchant store engine customer information and receiving by the first processor a request to enroll in an installment plan for the purchase of one or more goods or services. The method further includes the steps of forwarding by the first processor the customer information from the merchant store engine to a loan management engine to obtain a financing decision and processing by a second processor the customer information. The method also includes the steps of providing by the second processor the decision to the merchant store engine, transmitting by the second processor loan documents from the loan management engine to the merchant store engine, and creating by the second processor an installment plan at the loan management engine.

### CROSS REFERENCE TO RELATED APPLICATION

This application claims the benefit of U.S. Provisional Patent Application Ser. No. 61/869,903, filed Aug. 26, 2013, the contents of which is incorporated herein by reference.

### BACKGROUND

1. Field of the Invention

The present invention relates generally to systems and methods of enrolling customers in an installment plan to purchase goods and/or services at a point of sale.

2. Description of the Background

Previously, the options for purchasing goods or services at a point of sale (POS) have been limited to, for example, cash (if the POS is a physical location), credit card, check, debit card, and PayPal®. As discussed herein, POS refers to a physical location, such as a store front, or a virtual location, such as a website or other similar non-physical location.

POS terminals have not been capable, until recently, of allowing enrollment of customers in installment plans to pay for goods and/or services. Merchants that do allow for installment plans oftentimes do not allow a customer to enter into an installment plan for an item or items under a certain dollar amount or the process is largely manual and takes hours to complete. Oftentimes, the costs associated with allowing a customer to enter into an installment plan for low cost items is too great to justify offering installment plans to such customers. There exists a need to efficiently initiate and service an installment plan such that low cost items may be purchased by customers using installment plans.

### SUMMARY

In illustrative embodiments, a method for enrolling a customer in an installment plan by way of a loan management system may comprise the step of receiving by a first processor at a point of sale terminal within a merchant store engine customer information. The method may further comprise the steps of receiving by the first processor at the point of sale terminal operated at a merchant store a request to enroll in an installment plan for the purchase of one or more goods or services, wherein the request to enroll in an installment plan is the main means for payment, and forwarding by the first processor the customer information from the merchant store engine to a loan management engine over a network to obtain an approval or denial for an installment contract. The method may further include the steps of processing by a second processor at the loan management engine the customer information and providing by the second processor an installment plan financing decision to the merchant store engine. Still further, the method may include the steps of transmitting by the second processor loan documents from the loan management engine to the merchant store engine for execution by the customer and upon execution of the loan documents by the customer at the POS terminal, creating by the second processor an installment plan at the loan management engine.

In some embodiments, the point of sale terminal is a physical point of sale terminal.

In some embodiments, the method may further include the steps of servicing by the second processor the installment plan at the loan management engine by automatically debiting a customer's financial account on a recurring basis and reducing the customer's balance by an amount that was debited and depositing by the second processor money from the debiting of the customer's financial account into a financial account for later distribution.

In some embodiments, the method may further include the step of selectively apportioning and distributing by a third processor at a financing engine the money in the financial account to the merchant store and a party hosting the loan management engine.

In some embodiments, the method may further comprise the steps of requesting by the second processor at the loan management engine customer parameters from a merchant store, wherein the customer parameters include account history for the customer and applying logic by the second processor at the loan management engine on the parameters to determine eligibility of the customer for an installment plan.

In some embodiments, the method may further include the steps of accessing by the first processor, an application programming interface table and determining, based on the application programming interface table, whether the customer is approved for installment plan financing.

In some embodiments, the method may further comprise the step of transmitting by the second processor financing terms to the merchant store engine to display on the point of sale terminal.

In some embodiments, the loan management engine and the merchant store engine are located in two different physical locations and are operated by two different entities. In other embodiments, the loan management engine, the merchant store engine, and the financing engine are located in three different physical locations and are operated by three different entities.

In another illustrative embodiment, a loan management system comprises a merchant store engine, a financing engine, and a loan management engine comprising a memory having program code stored therein and a processor in communication with the memory for carrying out instructions in accordance with the stored program code. The program code, when executed by the processor, causes the processor to perform the operations comprising receiving by the processor customer information from the merchant store engine and requesting by the processor customer parameters including account history for the customer from the merchant store engine. The operations may further comprise receiving by the processor the customer parameters, applying logic to the customer parameters to determine eligibility of the customer in the installment plan, transmitting by the processor in real-time an approval for enrollment of the customer in an installment plan to the merchant store engine, and transmitting by the processor loan documents to the merchant store engine. The operations may further comprise receiving by the processor loan documents executed by the customer, creating by the processor an installment contract for the customer by which the customer is required to pay a balance in installments, and transmitting by the processor information about the installment contract to the financing engine.

In a further illustrative embodiment, a loan management system comprises a loan management engine, a financing engine, and a merchant store engine comprising a memory having program code stored therein and a processor in communication with the memory for carrying out instructions in accordance with the stored program code. The program code, when executed by the processor, may cause the processor to perform the operations comprising transmitting by the processor customer information to the loan management engine, transmitting by the processor a customer assent form to the loan management engine, and receiving by the processor an approval or denial for enrollment in an installment plan from the loan management engine. The operations may further comprise receiving by the processor in real-time loan documents for execution by the customer, transmitting by the processor executed loan documents to the loan management engine, and receiving by the processor in real-time an installment contract for the customer by which the customer is required to pay a balance in installments.

### BRIEF DESCRIPTION OF THE DRAWINGS

FIG. 1 is a diagrammatic view of a loan management system for initiating and servicing installment plans;

FIG. 2 is a flow diagram depicting a first embodiment of a method of implementing a point of sale (POS) installment plan;

FIG. 3 is a flow diagram depicting a second embodiment of a method of implementing a POS installment plan;

FIG. 4 depicts simplified exemplary transaction files transmitted from a merchant store engine to a loan management engine;

FIG. 5 is a diagram of a finance process for any of the POS installment plans disclosed herein;

FIG. 6 is a simplified exemplary settlement file sent from the loan management engine to the merchant store engine;

FIG. 7 is a decision tree for a customer call center;

FIG. 8 is a decision tree for a sales associate call center;

FIGS. 9A and 9B are flow diagrams depicting steps taken after logging into a POS terminal, which is part of the merchant store engine of the loan management system; and

FIG. 10 is a flow diagram depicting a further embodiment of a method of implementing a POS installment plan, the communications between system components during enrollment of a customer in an installment plan, and the flow of information during enrollment.

Other aspects and advantages of the present invention will become apparent upon consideration of the following detailed description, wherein similar structures have like or similar reference numerals.

### DETAILED DESCRIPTION

The present invention is directed to enrollment of customers in installment plans for low-cost goods and services and methods of allowing a consumer to purchase low-cost goods and/or service and pay for such goods and/or services by way of an installment plan. While the present invention may be embodied in many different forms, specific embodiments are discussed herein with the understanding that the present invention is to be considered only as an exemplification of the principles of the invention, and it is not intended to limit the invention to the embodiments illustrated.

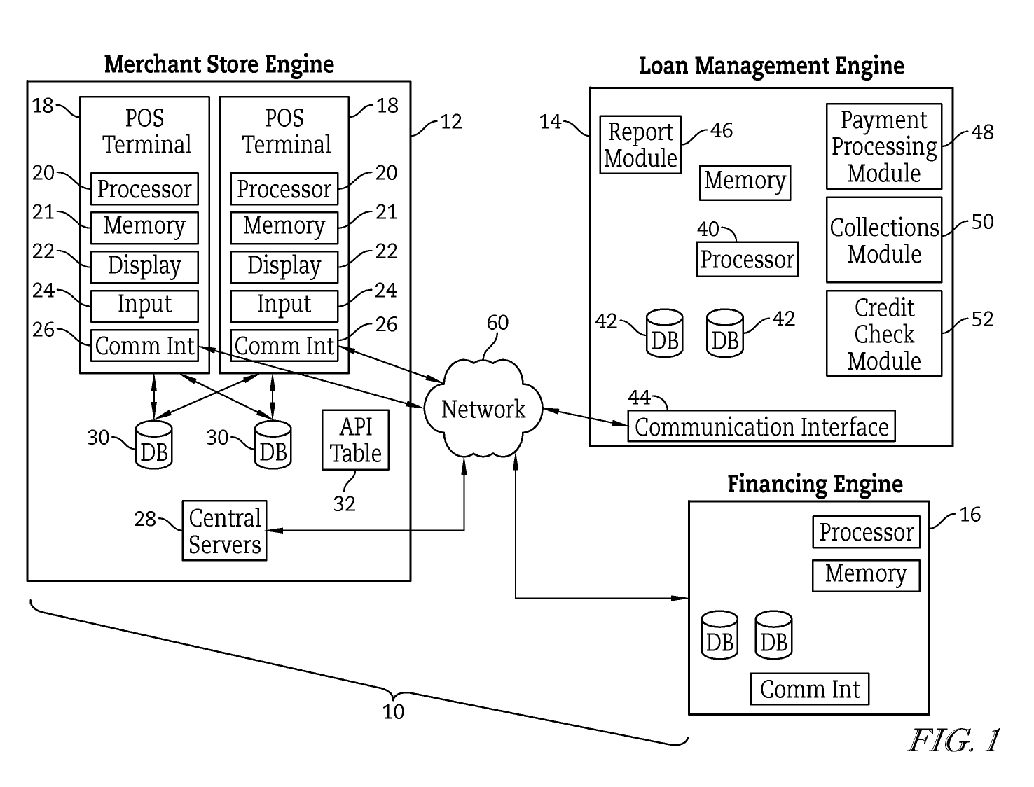

Referring to FIG. 1, a loan management system 10 for offering, completing the steps necessary to initiate and enroll a customer, and service an installment plan for the purchase of one or more products may include a merchant store engine 12, a loan management engine 14, and a financing engine 16. In exemplary embodiments, the goods are illustratively mobile devices and/or accessories for mobile devices. The merchant store engine 12 includes any number of POS terminals 18 at which a loan transaction for an installment plan may be processed. Each POS terminal 18 may include a processor 20 (e.g., a central processing unit (CPU)), memory 21, a video adapter (not shown) that drives a display 22 (e.g., a liquid crystal display (LCD) or a cathode ray tube (CRT)) for displaying information input into the terminal or received by the terminal, one or more input or peripheral devices 24, for example, a keyboard, a mouse, a printer, a digital signature pad, or any other suitable input or peripheral devices, a disk drive unit (not shown), and a communication interface 26 that allows communication between each POS terminal 18 and other devices or systems, for example, other POS terminals 18, an optional central server 28, the loan processing engine 14, and/or the financing engine 16. One skilled in the art will understand that each POS terminal 18 may include one or more of such components and/or any other suitable components. While only two POS terminals 18 are depicted, any number of POS terminals 18 may be employed. The POS terminals 18 may be in communication with one or more central servers 28, central databases 30, and/or an API table 32, as will be discussed in greater detail hereinafter.

The disk drive unit (not shown) includes a computer-readable medium on which is stored one or more sets of computer instructions and data structures embodying or utilized by the POS terminals 18. The computer instructions and data structures may also reside, completely or at least partially, within the memory 21 and/or within the processor 20 during execution thereof by the POS terminal 18, accordingly, the memory 21 and the processor 20 also constitute computer-readable media. Embodiments are contemplated in which the POS terminals 18 and/or another component of the merchant store engine 12, for example, a central server 28, may transmit or receive over a network 60 computer instructions or data via the communication interfaces 26 or through a communication interface of the central server utilizing any one of a number of transfer protocols including but not limited to the hypertext transfer protocol (“HTTP”) and file transfer protocol (“FTP”).

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

The POS terminals 18 (or other component of the merchant store engine 12) may be in communication with the loan management engine 14 through the communication interfaces 26 over the network 60 via a wireless communication device in the POS terminals 18, such as a WiFi connection, a Bluetooth connection, or any other suitable wireless communication device. The network 60 may be any type of communication scheme including, but not limited to, fiber optic, cellular, wired, and/or wireless communication capability in any of a plurality of protocols, such as TCP/IP, Ethernet, WAP, IEEE 802.11, or any other protocol. The merchant store engine 12 may transmit (e.g., through the POS terminals or the central server 28, for example) information to the loan management engine 14, for example, sales performance data, customer demographic data, credit card data, customer information, and/or any other suitable data.

The loan management engine 14 may include a processor 40, one or more databases 42, a communication interface 44, any number of modules, and/or any other suitable components. The loan management engine 14 may include any number of separate, embedded, and/or interconnected modules, which allow enrollment of a customer in an installment plan and/or service the installment plan. In illustrative embodiments, exemplary modules include, but are not limited to, a report module 46 for providing reporting on customer loans, a payment processing module 48 for processing installments received by customers on a recurring basis and/or depositing such installments in a financial account, a collection module 50 for tracking customer accounts that are delinquent, and/or a credit check module 52 for checking credit of customers prior to approval of an installment plan. While a number of different modules are discussed herein, one skilled in the art will understand that not all disclosed modules are necessary, additional modules may be utilized, and/or different modules may be utilized. Exemplary modules may be capable of receiving and storing customer information, including data fields and documentation, for example, for customer contracts. The loan management engine 14 may additionally or alternatively include any number of modules for servicing loans by collecting installments from customers, providing a customer-facing call center, and/or providing outbound collections calling. The loan management engine 14 may also additionally or alternatively include one or more modules for transmitting cash received from installment plans to the bank account of the appropriate entities (e.g., the merchant store and/or a third party financing entity). While each of the modules is shown as an individual module, any number of the described modules may be combined. The loan management engine 14 may be hosted by a third party service or, optionally, may be hosted by the merchant store.

For the purpose of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

While the loan management engine 14 is depicted as having a number of different components, one skilled in the art would understand that any suitable components may incorporated within the loan management engine 14 including, but not limited to, one or more input or peripheral devices, one or more central servers, one or more displays, and/or any other suitable components.

The financing engine 16 may receive daily activity reports, portfolio reports, and/or any other information relating to the installment plans in which customers enrolled at any number of different merchant stores 202, for example, carrier stores, dealers, and/or retailers. The financing engine 16 may additionally track, receive, and distribute funds received from customers by way of payment on their installment plans. In an illustrative embodiment in which the financing engine 16 services installment plans for 100,000 customers at various merchant stores 202, the loan management engine 14 may, on a periodic basis (i.e., daily, weekly, monthly, or at any other suitable interval) collect installments from all or a portion of the 100,000 customers (e.g., if on a weekly basis, only a fraction of the customers may be schedule to pay their installment) and deposits the collected funds into a financial account, for example, associated with a financing entity operating and/or hosting the financing engine 16. The financing engine 16 may then distribute the funds collected from customers to any number of different entities, for example, the merchant stores 202, a loan management service hosting the loan management engine 14, and/or a software provider that has developed and/or services software at the POS terminals 18 at the merchant store 202. A financing entity operating and/or hosting the financing engine 16 may also keep a portion of the collected funds as a service fee.

Still referring to FIG. 1, the financing engine 16 may include any number of components, for example, a processor 80, memory 82, any number of databases 84, and a communication interface 86. While the financing engine 16 is described as having a number of different components, one skilled in the art will understand that the financing engine 16 may include any number of additional or alternative components including, but not limited to, input and peripheral devices, central servers, modules, and the like. The financing engine 16 communicates with the loan management engine 14 through the communication interface 86 and over the network 60 to receive the necessary information to track, receive, and distribute funds received from customers by way of payment on their installment plans. The financing engine 16 may also forward any relevant information to the loan management engine 14 in the same manner.

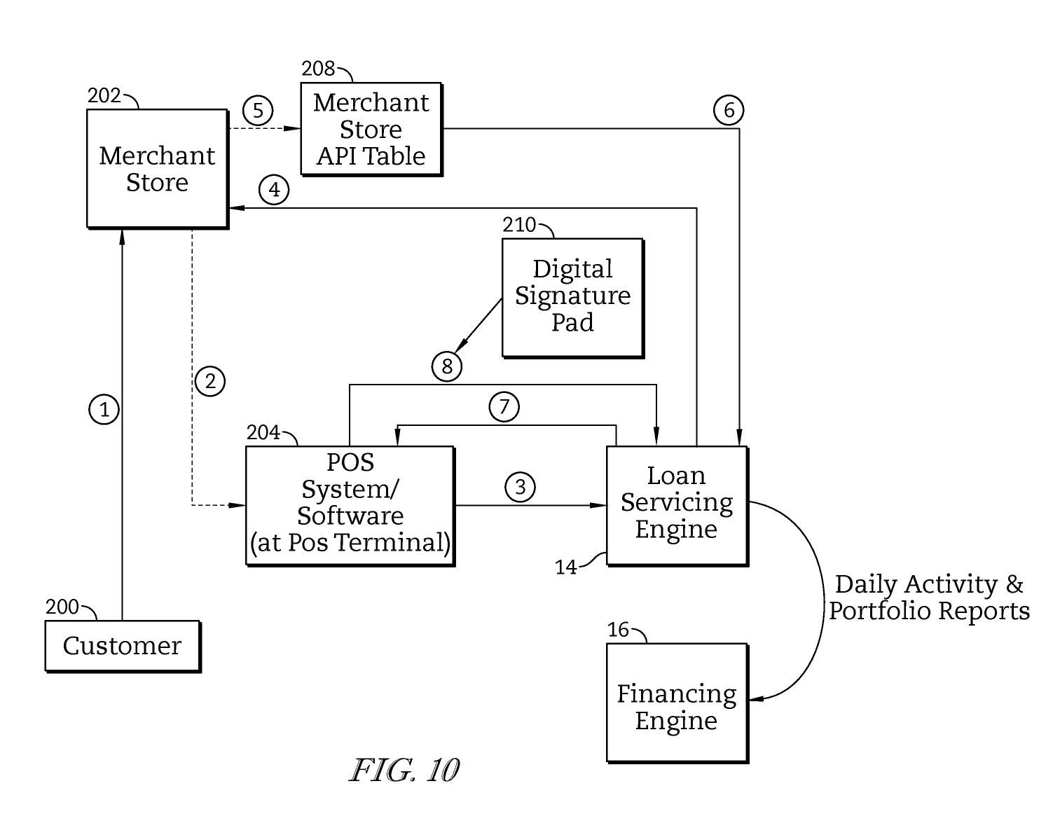

During enrollment of a customer in an installment plan, the POS terminals 18 may communicate through their respective communication interfaces 26 over the network 60 with the loan management engine 14 by way of its communication interface 44. The transfer of information between the merchant store engine 12 (by way of the POS terminals 18 or the optional central server 28) and the loan management engine 14 will be discussed in greater detail hereinbelow in relation to FIG. 10.

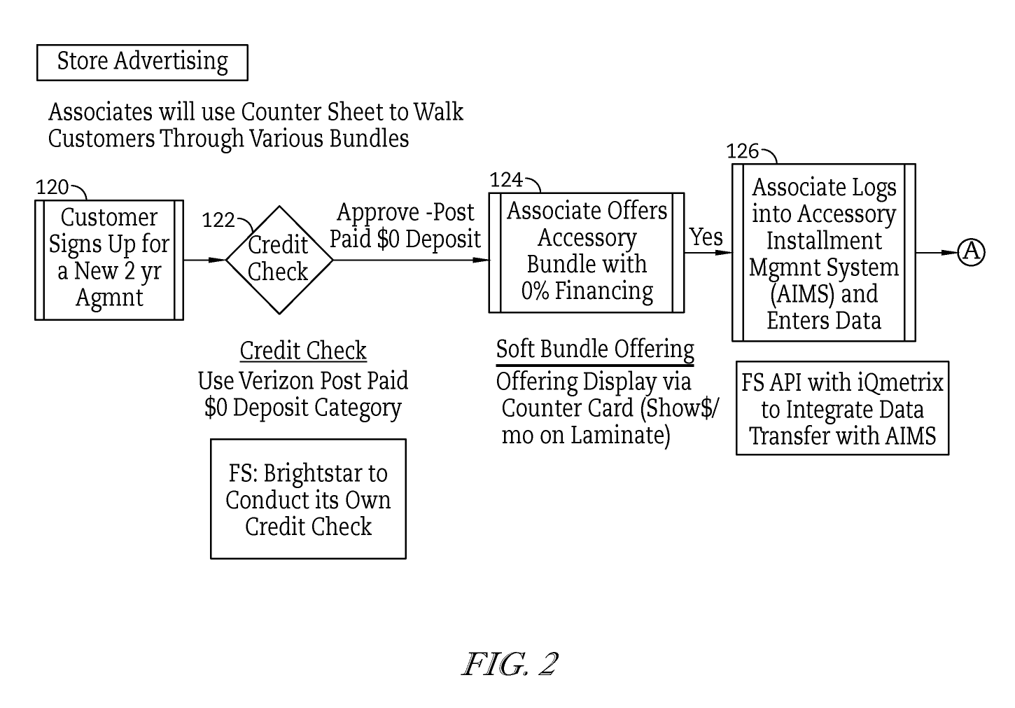

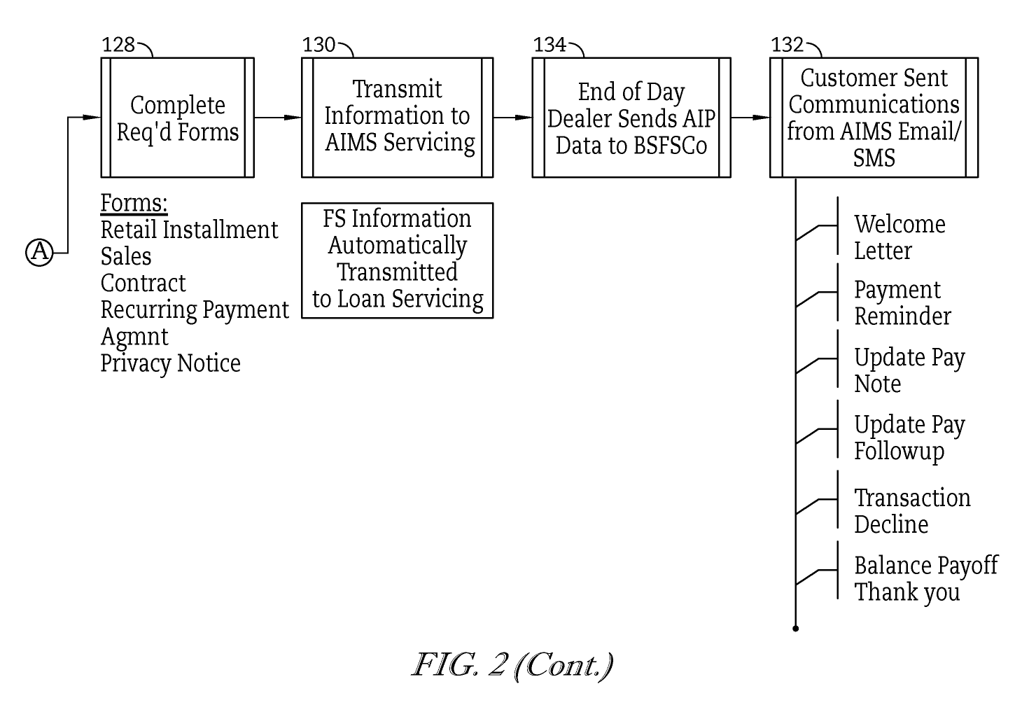

Referring to FIGS. 2 and 3 of the attached drawings, high-level methods of implementing accessory installment plans are shown. The process begins when a customer enters a merchant store, which may be a carrier store (i.e., TMobile, Verizon, AT&T, etc.), a dealer, a retailer (i.e., Target, Wal-Mart, etc.), or any other establishment that sells mobile devices and accessories for mobile devices and allows a customer to sign a mobile device contract with a carrier. After signing a contract, for example, a two-year contract at block 120, a customer's credit may be checked by a sales associate at block 122 through an external program, for example, a web-based program or through a software program integrated with the store's point of sale (POS) system. At any point in the methods of FIGS. 2 and 3, the method may be interrupted and/or terminated should the customer not wish to proceed any further.

In an exemplary embodiment, if the customer's credit check is approved, the sales associate offers the customer an accessory bundle at 0% financing at block 124. The sales associate may use advertising materials, for example, placards, pamphlets, a sell sheet, or any other suitable materials to assist in the sale of accessories. The advertising materials may include separate accessories or bundles of accessories for sale. Exemplary bundles may be those for the athlete, the business man, the stay-at-home mom, the music lover, or any other suitable bundles.

If the customer selects accessories or a bundle of accessories, the sales associate then uses on of the POS terminals 18 or a web-based program to log into the loan management system (LMS) 10 (also called an accessory installment management system (AIMS)) at block 126. The sales associate enters customer data, for example, name, address, cell phone number(s), home phone number, bank account routing information, bank account number, credit card number, expiration date, and security code, state issue identification, total amount spent, and/or total amount financed. While specific data is disclosed as being input by the sales associate, any suitable data may be collected and/or input by the sales associate.

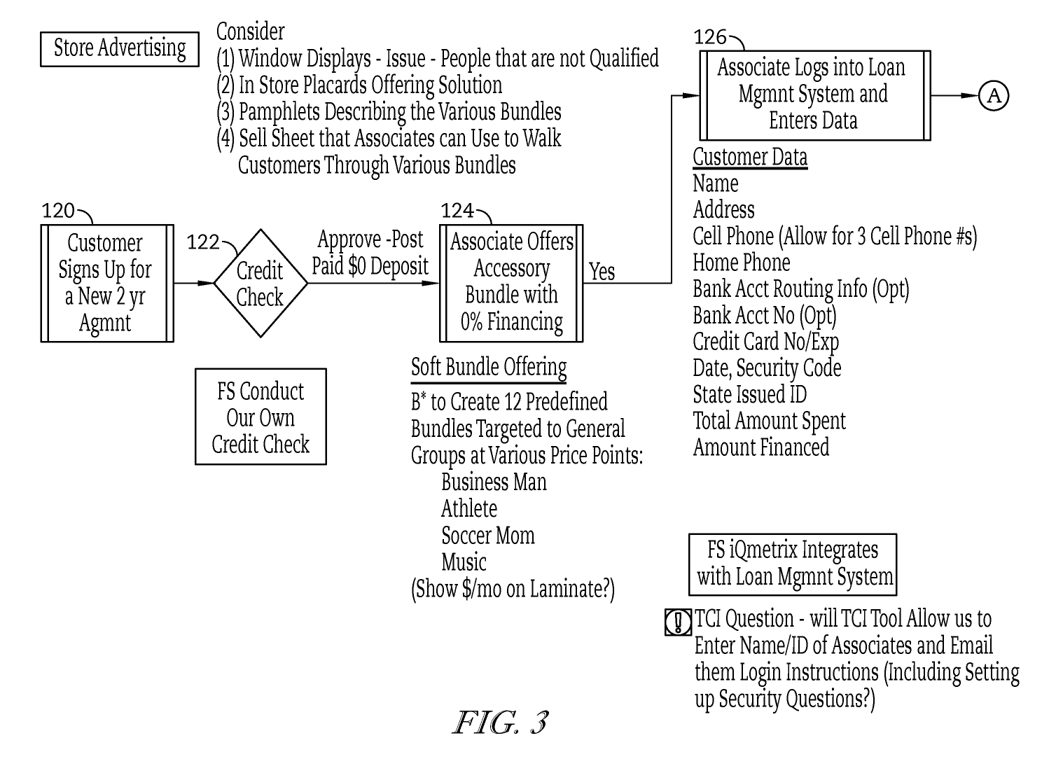

At block 128, the sales associate works with the customer to complete all required forms, for example, a retail installment sales form, a contract, a recurring payment agreement, and/or a privacy notice. Any other suitable forms may additionally or alternatively be completed. Once the forms are completed, information collected from the customer is entered into the merchant store engine 12 by the sales associate and is transmitted to the loan management engine 14 at block 30. After processing by loan management engine 14, the customer receives a welcome email at block 132. In the future, loan management engine 14 may send additional emails, text messages, or other electronic communications to the customer, for example, communications regarding payment reminders, balance payoff, a declined transaction, updates, and/or any other suitable communications. Emails, text messages, or other electronic communications may include a link that a user may click to view the store or accessory installment plan website. At the end of a day, the store forwards information regarding all new accessory installment plans for that day to a processing agent (BSFSCo) at block 134. Optionally, blocks 132 and 134 may be reversed, as seen in FIGS. 2 and 3. A simplified sample transaction file that may be sent to the processing agent is depicted in FIG. 4. Optionally, a transaction file may be sent on a semi-weekly, weekly, monthly, or any other suitable basis.

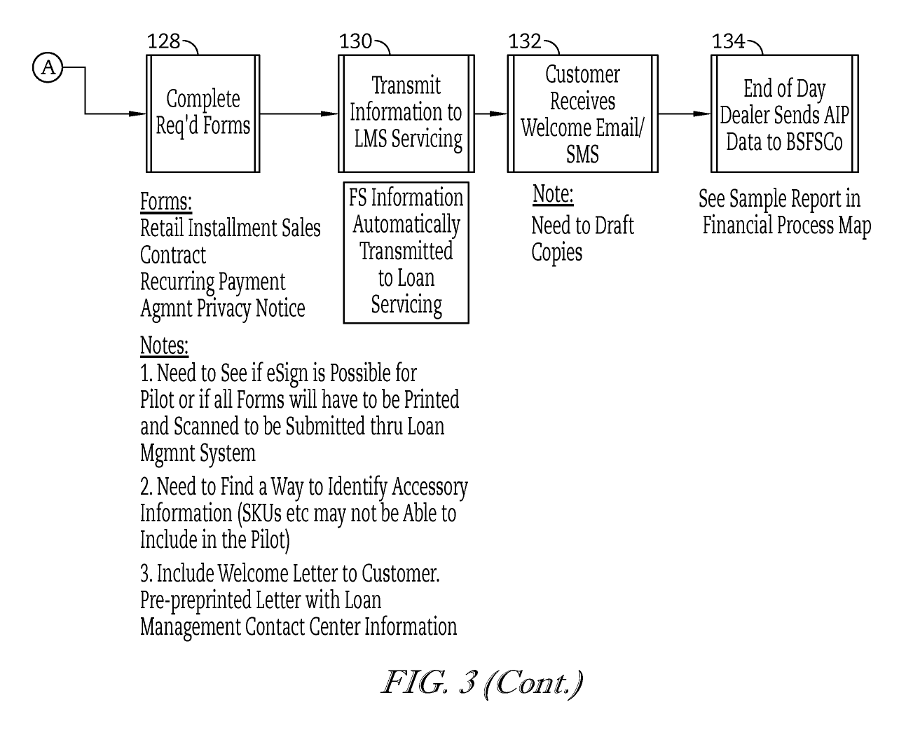

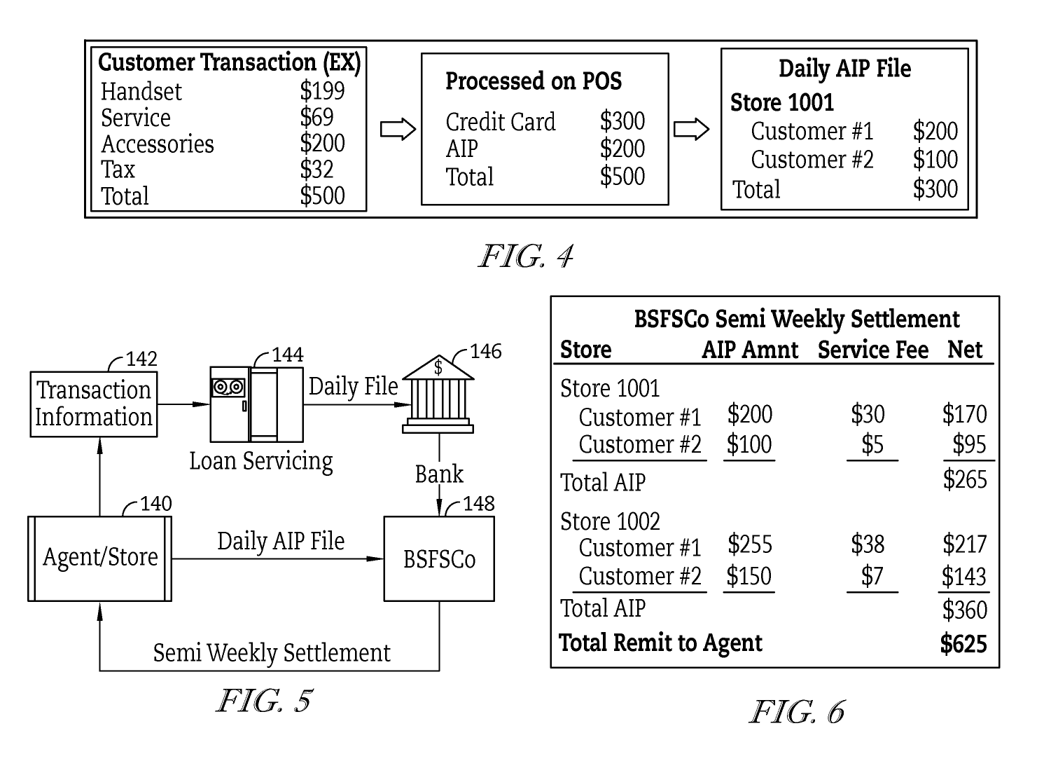

Referring to FIG. 5, the merchant store 140 (e.g., the POS terminals 18 and/or central server 28 of the merchant store engine 12) may send transaction information 142 to the loan management engine 14 on a transactional basis. The loan management engine 14 may forward a transaction file to a banking partner 146. As noted above, the merchant store 140 may also send a transaction file on a daily basis to a processing agent 148 (which may be the financing engine 16). On a semi-weekly basis, the processing agent 148 may transmit settlement information to the merchant store 140 with a settlement file, as seen in FIG. 6. The settlement file of FIG. 6 is intended to be an illustrative example and could include any additional or alternative detail therein. While certain files or transactions are described as being sent on a daily, semi-weekly, or weekly basis, the files and/or transactions may occur at any suitable interval.

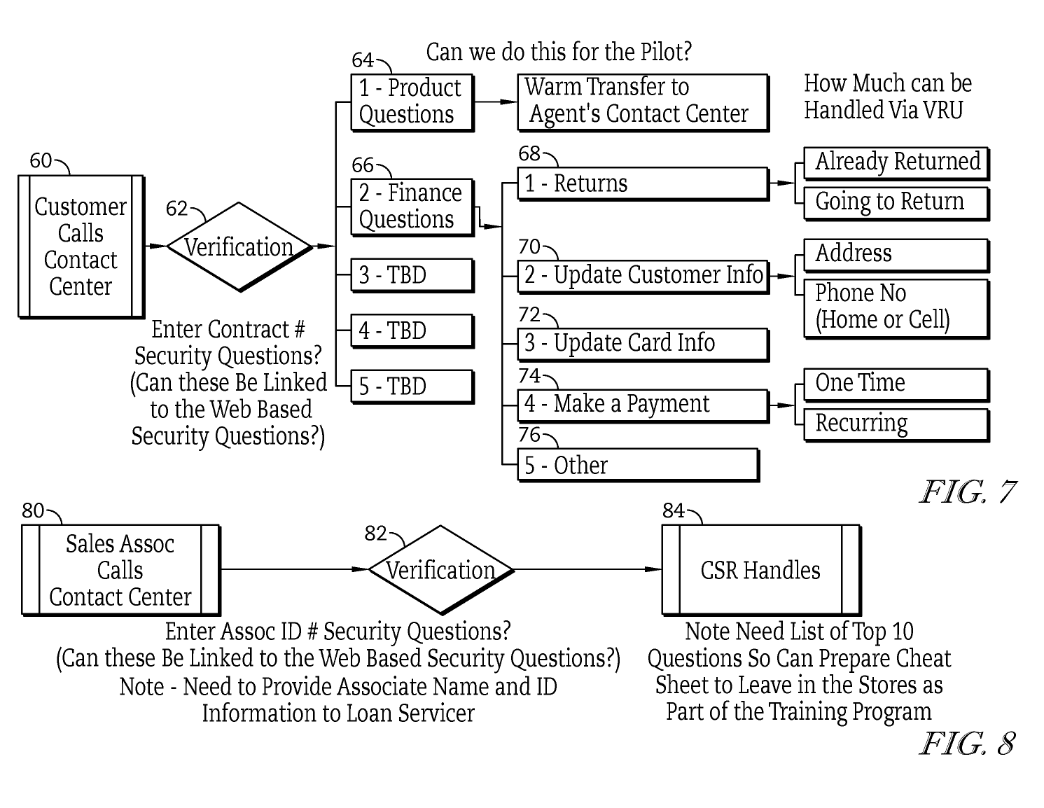

A service or inquiry process, as seen in FIG. 7, may be implemented as part of the accessory installment plans described herein. A customer may contact a call center for assistance at block 160. Upon contacting the call center, an automated message verifies the identification of the customer at block 162, for example, by asking identifying information and/or security questions. Once a customer is verified, the customer is asked what type of question they have, for example, a product question 164, a finance question 166, or any other suitable type of question. Once the customer selects the appropriate type of question, the customer may again be asked to narrow the type of question. For example, if the customer has a finance question 166, the customer may be asked if the finance question 166 relates to returns 168, updating customer information 170, updating card information 172, making a payment 174, or another type of finance question 176. Each question can be narrowed any number of times and any number of different criteria may be used to narrow a customer's inquiry such that the customer can be provided with the desired information.

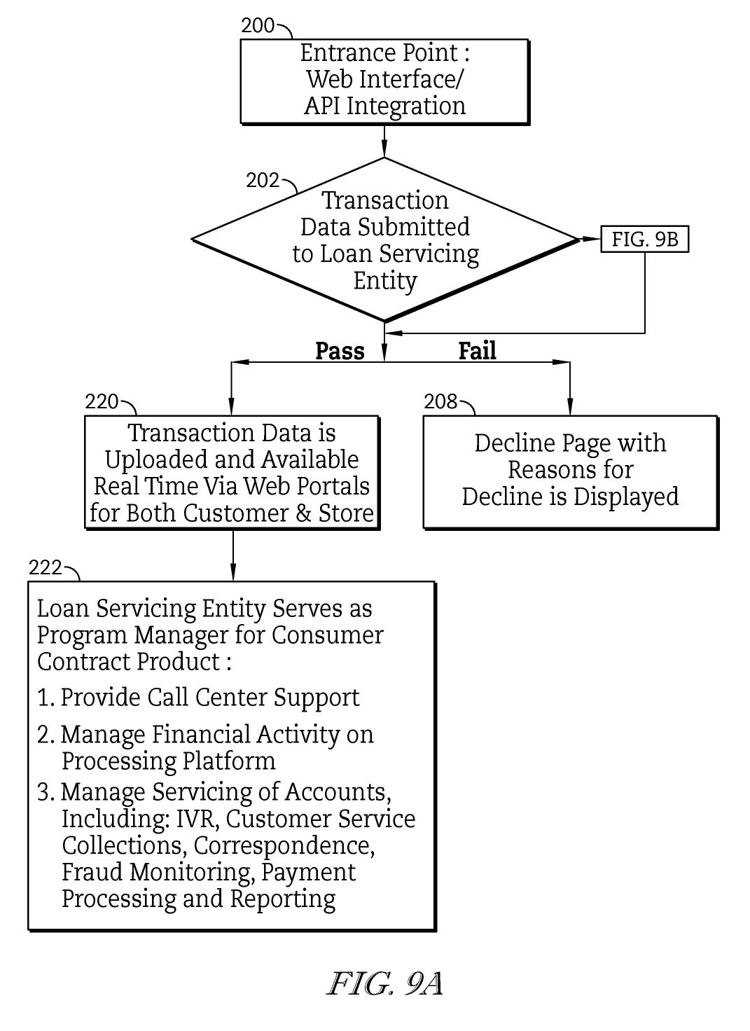

In another service or inquiry process, as seen in FIG. 8, a sales associate at the store may contact the call center at block 180. As in the service process of FIG. 7, an automated message verifies the identification of the sales associate at block 182, for example, by asking identifying information (e.g., an associate identification number) and/or security questions. The call center may then handle the call in the same manner as described with respect to FIG. 7, as indicated at block 184.

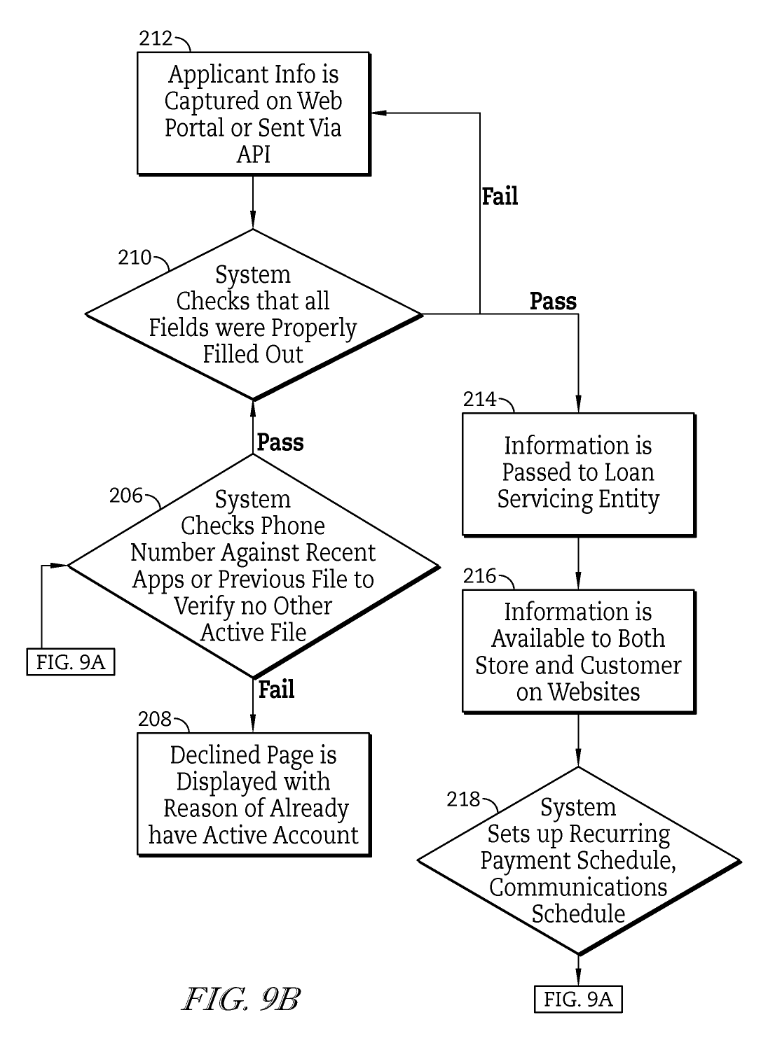

Referring to FIGS. 9A and 9B, an entrance point, for example, a software program or a web interface, may be provided at the store (e.g., on the POS terminals 18) or virtually (e.g., through a website) for access to the loan management system 10. At block 200 of FIG. 9A, the sales associate enters the software program or web interface. Transaction data is forwarded from the merchant store engine 12 to the loan management engine 14 at block 202. Referring to 9B, once the loan management engine 14 receives the transaction data, a phone number of the customer is checked against recent applications or previous files to verify the customer has no other active files at block 206. If the customer already has an active account, a page indicating that the transaction is declined appears at block 208. If the customer does not have an active account, processing passes to block 210, wherein the loan management engine 14 checks to see if all fields were properly filled out. If one or more fields is not properly filled out, the sales associate is asked at block 212 to insert the proper information. Processing keeps passing to block 210 until all entered information is proper. At that point, processing passes to block 214 wherein the entered information is processed by the loan management engine 14. After the loan management engine 14 processes the information, the information is available to the store and the customer on one or more appropriate websites (e.g., through the POS terminals 18) or through any other suitable program or interface at block 216 and the loan management engine 14 sets up recurring payment and communication (e.g., payment reminders) schedules for the customer at block 218. In any of the embodiments herein, a request for enrollment of a customer in an installment plan may be declined for any number of reasons or combination of reasons. More particularly, a number of parameters may be examined and, based on such parameters, the request for an installment plan may be approved or declined, as discussed in more detail herein below.

If processing successfully passes through the steps of FIG. 9B, the transaction information is uploaded and available in real time through web portals or through any other suitable program or interface for the customer and the store at block 220. The loan management engine 14 thereafter manages the servicing of the customer account, provides call center support, and manages financial activity, as seen at block 222.

Referring to FIG. 10, the flow of information within the loan management system 10 to create an installment plan according to a further embodiment herein is depicted. In a first implementation, the flow of FIG. 10 is utilized for a “New Customer”. A new customer 300 enters the merchant store 302 (or in an alternative embodiment, a merchant website). At Step 1, the customer 300 provides their name, address, phone number, and/or any other relevant information to a sales associate at the merchant store 302 for a credit check. The sales associate enters the appropriate information from the customer 300, as detailed above, into a POS terminal 18 of the merchant store 302 POS system 304, which quickly provides approval for a mobile device from the merchant store 302. At Step 2, the customer is approved for a mobile device, but is only verbally offered an installment plan pending approval. If the customer 300 indicates that he would like to purchase, for example, a number of accessories by way of an installment plan (and/or optionally the mobile telephone), the sales associate at the merchant store 302 indicates that the customer is interested in an installment program (e.g., by depressing a “financing” button). The customer is then required to sign, fill out, or check a box (e.g., on a digital signature pad 310) indicating that they consent to sharing the customer's information with one or more third parties to determine eligibility for enrollment, enroll, and service an installment plan. Once the customer provides their consent, the sales associate enters all necessary information into the POS terminal 18 of the POS system 304 at Step 2, which initiates an installment plan enrollment process by sending the appropriate information from the customer 300 to the loan management engine 14 at Step 3. At Step 4, the loan management engine 14 contacts the merchant store engine 12 at the merchant store 302 to retrieve parameters used in determining eligibility of the customer for an installment plan. Parameters may include, but are not limited to, missed or overdue payments by the customer (if already a customer), any issues with the customer account, a number of lines for which the customer has been approved, a credit score, other account information, and/or any other suitable parameters.

The merchant store engine 12 at the merchant store 302, thereafter at Step 5, retrieves the requested parameters from an application programming interface (API) table 308 and transmits the relevant parameters to the loan management engine 14. More particularly, the API table is a look-up table having a number of different parameters for each customer, whereby if certain parameters are met, the customer is approved for installment plan financing. At step 6, the merchant store engine 12 returns the relevant, requested parameters to the loan management engine 14 based on the API table 308. The API table 308, in an illustrative embodiment, may be hosted by the merchant store 302. The loan management engine 14 may then use logic and the parameters received from the merchant store engine 12 (API table 208) to determine eligibility (approval or denial) of the customer for an installment plan. At Step 7, the loan management engine 14 then transmits the decision on eligibility to the merchant store engine 12 by way of the POS terminal 18. If the credit decision is an approval, the loan management engine 14 may also forward the terms of the financing, for example, a maximum credit line, number of installments, installment amount, and/or any other financing terms. The loan management engine 14 may at that time, or at a later time after the customer has made a final decision with regard to purchases to be financed, also forward loan documents to the merchant store engine 12, wherein the loan documents are accessible for viewing and printing on, for example, a POS terminal 18 of the POS system 304. The loan documents may be printed, signed, and uploaded into the system and/or the POS terminal 18 may be equipped, for example, with a digital signature pad 310 for viewing and/or providing a signature for the loan documents. As noted above, activity and portfolio reports may be forwarded to the financing engine 16 or other third party on a periodic basis, for example, hourly, daily, weekly, monthly, or at any other suitable intervals.

In a second implementation, the flow of FIG. 10 is utilized for an “Upgrade” for a current customer. A current customer 300 enters the merchant store 302 (or in an alternative embodiment, a carrier website). At Step 1, the customer 300 provides their name, address, account number, and/or any other relevant information to a sales associate at the merchant store 302 to look up the customer's account. The sales associate may check to see if the customer is eligible for an upgrade and/or is in good standing. The sales associate enters the appropriate information from the customer 300, as detailed above, into the merchant store 302 POS terminal 18 of the POS system 304. If the customer 300 indicates that he would like to purchase, for example, a number of accessories by way of an installment plan (and/or optionally a mobile device), the sales associate at the merchant store 302 requests that the customer sign, fill out, or check a box (e.g., on a digital signature pad 310) indicating that they consent to sharing the customer's information with one or more third parties to determine eligibility for enrollment, enroll, and service an installment plan. Once the customer provides their consent, the sales associate enters selects a financing transaction at the POS terminal 18 of the POS system 304 at Step 2 (e.g., by depressing a “financing” button), which initiates an installment plan enrollment process by sending the appropriate information from the customer 300 to the loan management engine 14 at Step 3. At Step 4, the loan management engine 14 contacts the merchant store engine 12 at the merchant store 302 to retrieve parameters used in determining eligibility of the customer for an installment plan. Parameters may include, but are not limited to, missed or overdue payments by the customer (if already a customer), a number of lines for which the customer has been approved, a credit score, and/or any other suitable parameters.

It should be noted that two different approvals may be necessary during the “New Customer” process (or any other process). For example, a credit check may be conducted to allow a customer to purchase, for example, a mobile device on installment from, for example, the merchant store. In such an example, the customer may pay a monthly fee directly to the merchant store, for example, as part of their monthly mobile device bill. In the same example, a check on eligibility in the installment plan may be conducted, in which the a third party services the loan.

The merchant store engine 12 at the merchant store 302, thereafter at Step 5, retrieves the requested parameters from the application programming interface (API) table 308, as detailed above with respect to the first implementation. At Step 6, the merchant store engine 12 transmits the relevant parameters to the loan management engine 14 based on the API table 308. The loan management engine 14 may then use logic and the parameters received from the merchant store engine 12 (API table 208) to determine eligibility (approval or denial) of the customer for an installment plan. At Step 7, the loan management engine 14 then transmits the decision on eligibility to the merchant store engine 12 by way of the POS terminal 18. If the credit decision is an approval, the loan management engine 14 may also transmit the terms of the financing, for example, a maximum credit line, number of installments, installment amount, and/or any other financing terms. The loan management engine 14 may at that time, or at a later time after the customer has made a final decision with regard to purchases to be financed, also forward loan documents to the merchant store engine 12, wherein the loan documents are accessible for viewing and printing on, for example, the POS terminal 18 of the POS system 304. The loan documents may be printed, signed, and uploaded into the system and/or the POS terminal 18 may be equipped, for example, with a digital signature pad 210 for viewing and/or providing a signature for the loan documents. As noted above, activity and portfolio reports may be forwarded to the financing engine 16 or other third party on a periodic basis, for example, hourly, daily, weekly, monthly, or any other suitable time period. The second implementation may additionally be used for a standalone customer or a customer that is not eligible for an upgrade and simply wants to purchase, for example, accessories on an installment plan.

As indicated above, in alternative embodiments, any implementation of FIG. 9 may be initiated through a virtual store front, for example, a web portal or any other suitable means. In such embodiments, the customer would enter, for example, the web portal, and begin a transaction. The loan documents may be digitally signed via a mobile telephone, computer, or any other interface and/or may be printed, signed, and uploaded.

The POS system 304 at the merchant store 302 may be provided by a third party and directly interfaces with the loan management engine 306. More specifically, the POS system 304 may include multiple POS terminals 18 that allow sales associates or other personnel to collect, enter, and transmit customer information to the loan management engine 14. In addition, once the relevant approval (or denial) is received from the loan management engine 14, the POS terminals 18 of the system 304 is capable of providing such a notification and also providing the necessary loan documents and allowing for execution of the loan documents.

The installment plans and the methods for implementing installment plans disclosed herein provide a way for customers to finance the purchase of products and/or services, for example, mobile devices and/or accessories for mobile device. Optionally, the methods and systems disclosed herein may be utilized for other products and/or services for which installment plans may be desirable. The installment plans and methods of implementing installment plans disclosed herein process hundreds of thousands of small loans in an efficient manner. The highly automated systems and methods disclosed herein provide a low-cost business model, thereby allowing small loan amounts at 0% financing. In addition, the entire loan process is highly automated to allow enrollment of a customer in an installment plan in a few minutes. Once a customer has signed a contract for new activation or an upgrade and has entered an accessory installment plan, the customer's credit or debit card or bank account is charged for an agreed amount on a monthly basis. The loan management system may automatically send payment reminders via email or text to customers, but the customers would not receive invoices.

The installment plans and methods of implementing installment plans disclosed herein provide the merchant store an opportunity to finance purchases without the overhead of typical installment plans. More particularly, during the enrollment process, the merchant store collects only the tax for a purchase and the rest of the purchase is financed by way of an installment plan. The entities hosting the loan management engine 14 and the financing engine 16, which may be different, service the installment plans, collect the monies due on the installment plans, and distribute any monies due to the merchant store on a recurring basis (i.e., weekly, monthly, or at any other suitable interval). This system enables merchant stores to offer financing options such as installment plans without the infrastructure necessary to provide such financing options.

While the functionality of the loan management system, for example, with respect to FIGS. 9A and 9B is disclosed as being accessible through a web interface, the store POS system may optionally be integrated with the loan management system so that accessing the loan management system is seamless.

Numerous modifications to the present invention will be apparent to those skilled in the art in view of the foregoing description. Accordingly, this description is to be construed as illustrative only and is presented for the purpose of enabling those skilled in the art to make and use the accessory installment plan and to teach the best mode of carrying out same.

We claim:

1. A method for enrolling a customer in an installment plan by way of a loan management system, the method comprising the steps of:
receiving by a first processor at a point of sale terminal within a merchant store engine customer information;
receiving by the first processor at the point of sale terminal operated at a merchant store a request to enroll in an installment plan for the purchase of one or more goods or services, wherein the request to enroll in an installment plan is the main means for payment;
forwarding by the first processor the customer information from the merchant store engine to a loan management engine over a network to obtain an approval or denial for an installment contract;
processing by a second processor at the loan management engine the customer information;
providing by the second processor an installment plan financing decision to the merchant store engine;
transmitting by the second processor loan documents from the loan management engine to the merchant store engine for execution by the customer; and
upon execution of the loan documents by the customer at the POS terminal, creating by the second processor an installment plan at the loan management engine.

2. The method of claim 1, wherein the point of sale terminal is a physical point of sale terminal.

3. The method of claim 1, further including the steps of:
servicing by the second processor the installment plan at the loan management engine by automatically debiting a customer's financial account on a recurring basis and reducing the customer's balance by an amount that was debited; and
depositing by the second processor money from the debiting of the customer's financial account into a financial account for later distribution.

4. The method of claim 3, further including the step of:
selectively apportioning and distributing by a third processor at a financing engine the money in the financial account to the merchant store and a party hosting the loan management engine.

5. The method of claim 1, further including the steps of:
requesting by the second processor at the loan management engine customer information from a merchant store, wherein the customer parameters includes account history information for the customer; and
applying logic by the processor at the loan management engine on the parameters to determine eligibility of the customer in an installment plan.

6. The method of claim 1, further including the steps of:
accessing by the first processor, an application programming interface table; and
determining, based on the application programming interface table, whether the customer is approved for installment plan financing.

7. The method of claim 1, further including the step of:
transmitting by the second processor financing terms to the merchant store engine to display on the point of sale terminal.

8. The method of claim 1, wherein the loan management engine and the merchant store engine are located in two different physical locations and are operated by two different entities.

9. The method of claim 4, wherein the loan management engine, the merchant store engine, and the financing engine are located in three different physical locations and are operated by three different entities.

10. A loan management system, comprising:
a merchant store engine;
a financing engine;
a loan management engine comprising a memory having program code stored therein and a processor in communication with the memory for carrying out instructions in accordance with the stored program code, wherein the program code, when executed by the processor, causes the processor to perform the operations comprising:
receiving by the processor customer information from the merchant store engine;
requesting by the processor customer parameters including an account history for the customer from the merchant store engine;
receiving by the processor the customer parameters;
applying logic to the customer parameters to determine eligibility of the customer in an installment plan;
transmitting by the processor in real-time an approval for enrollment of the customer in an installment plan to the merchant store engine;
transmitting by the processor loan documents to the merchant store engine;
receiving by the processor loan documents executed by the customer;
creating by the processor an installment contract for the customer by which the customer is required to pay a balance in installments; and
transmitting by the processor information about the installment contract to the financing engine.

11. A loan management system, comprising:
a loan management engine;
a financing engine;
a merchant store engine comprising a memory having program code stored therein and a processor in communication with the memory for carrying out instructions in accordance with the stored program code, wherein the program code, when executed by the processor, causes the processor to perform the operations comprising:
transmitting by the processor customer information to the loan management engine;
transmitting by the processor a customer assent form to the loan management engine;
receiving by the processor an approval or denial for enrollment in an installment plan from the loan management engine;
receiving by the processor in real-time loan documents for execution by the customer;
transmitting by the processor executed loan documents to the loan management engine; and
receiving by the processor in real-time an installment contract for the customer by which the customer is required to pay a balance in installments.
